(19) United States
(12) Patent Application Publication
(10) Pub. No.: US 2007/0116456 A1
(43) Pub. Date: May 24, 2007

(54) Advanced voice annotation on digital cameras

(76) Inventors: Eldho Kuriakose, Austin, TX (US); Srinivasan Kadathur, Austin, TX (US)

Correspondence Address: HAMILTON & TERRILE, LLP, P.O. BOX 203518, AUSTIN, TX, 78720, US

(21) Appl. No.: 11/284,590

(22) Filed: Nov. 22, 2005

(51) Int. Cl. G03B 17/24

(52) U.S. Cl. 396/310

(57) ABSTRACT

An apparatus for generating a digital image which includes a processor, a light sensor coupled to the processor which senses light and generates a digital image corresponding to the light, a memory coupled to the processor, an annotation module stored on the memory which enables annotation information to be associated with a specific position within the digital image is disclosed.

### BACKGROUND OF THE INVENTION

1. Field of the Invention

The present invention relates to the field of voice annotation on digital cameras.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

People have started taking pictures using digital cameras where the pictures are stored as digital images. Digital images are stored on various media some that are fixed in location (such as hard disks) and others that can be moved or mailed (such as media cards, diskettes, DVDs, or CDROMs). Digital images can also be transferred over communications media such as the internet, local networks, or even a USB (universal serial bus) cable connecting a digital camera to a personal computer.

Known digital cameras allow customers to associate voice or text annotations with a particular digital image. However, known designs allow a single annotation per image. Additionally, certain digital cameras provide a post processing option of annotating certain objects within a digital image.

Additionally, certain digital image formats allow for storing specific annotations for specific locations of the image. These annotation features are often manual and repetitive to create interactive image maps for web pages and presentations.

### SUMMARY OF THE INVENTION

In accordance with the present invention, a digital camera is provided with includes an annotation feature in which annotations are associated with specific locations within the digital image. In one embodiment, the annotation information is encapsulated within an industry standard interactive file format.

In one embodiment, the invention relates to an apparatus for generating a digital image which includes a processor, a light sensor coupled to the processor which senses light and generates a digital image corresponding to the light, a memory coupled to the processor, an annotation module stored on the memory which enables annotation information to be associated with a specific position within the digital image.

In another embodiment, the invention relates to an information handling system which includes a processor, a light sensor coupled to the processor which senses light and generates a digital image corresponding to the light, a memory coupled to the processor, and means for enabling annotation information to be associated with a specific position within the digital image.

In another embodiment, the invention relates to a method for generating a digital image which includes sensing light, generating a digital image corresponding to the light and associating annotation information with a specific position within the digital image.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a block diagram of an example digital camera.

FIG. 3 shows an example view a screen and controls of an example digital camera.

FIG. 4 shows a block diagram of an interactive file format for storing position specific annotation information.

### DETAILED DESCRIPTION

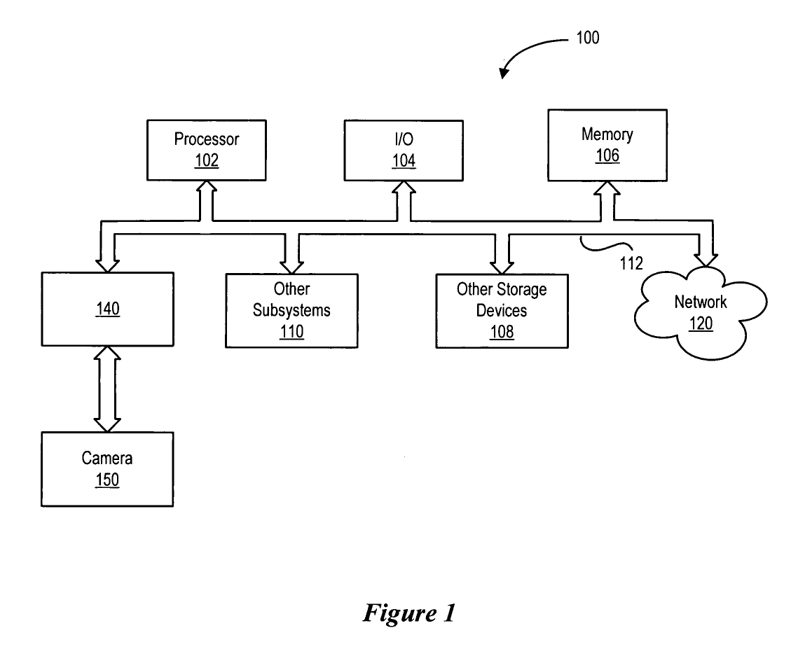

Referring briefly to FIG. 1, a system block diagram of an information handling system 100 is shown. The information handling system 100 includes a processor 102, input/output (I/O) devices 104, such as a display, a keyboard, a mouse, and associated controllers, non volatile memory 106, such as a hard disk and drive, and other storage devices 108, such as a floppy disk and drive and other memory devices, and various other subsystems 110, all interconnected via one or more buses 112. The information handling system 100 may be coupled to a network 120, e.g., via the bus 112. The information handling system may also include a connection device 140 which enables a camera or other type of content (e.g., image data) device to be coupled to the information handling system. For example, the information handling system 120 might include a USB or IEEE 1394 type of connector and controller.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. Additional examples of an information handling system may be a camera or video recorder.

The camera 150 (e.g., a digital camera) enables users to take pictures and save them in digital (electronic) format. The camera 150 enables users to take pictures (i.e., images), which are saved in memory within the camera 150 as digital image data. After taking and storing the images, the user can connect the digital camera 150 to the information handling system 100 to upload the digital images to the non-volatile memory 106 of the information handling system 100. Once the digital images are uploaded to the information handling system 100, the user can erase the digital images from the memory of the camera 150 so that the user can take and store additional images using the camera 150. Typically, the camera 150 is connected to the information handling system 100 only while the user is uploading images to the non-volatile memory 106 of the information handling system 100.

After the digital images are stored on the information handing system 100, a user can perform various operations on the digital images. For example, an image viewer application enables viewing the images or a photo editor application enables modifying or touching-up of the images. Also, an electronic messaging (e.g., e-mail) application enables transmission of the digital images to other users.

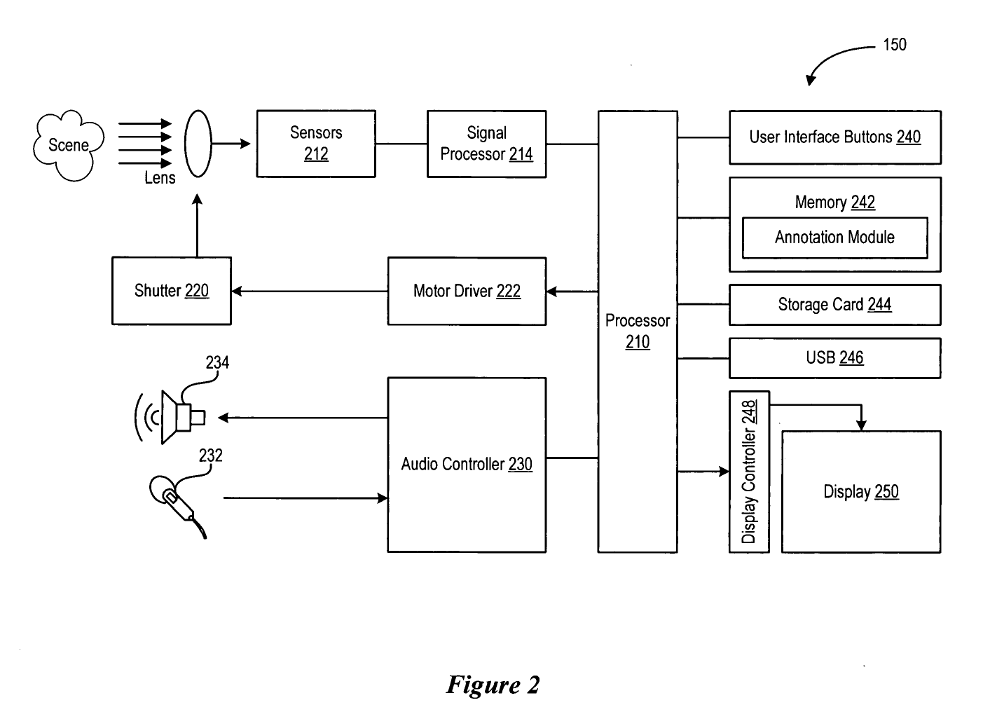

Referring to FIG. 2, a block diagram of an example digital camera 150 is shown. More specifically, an example digital camera 150 includes a processor 210 which is coupled to light sensors 212 (such as a charge coupled device (CCD) or complementary metal oxide semiconductor (CMOS) sensors) via a signal processor 214. The light sensors 212 are coupled to a lense 216. A shutter 220 is controlled via a motor driver 222 to admit light via the lense 216 to the light sensors 212. The motor driver 222 is also coupled to the processor 210.

The processor 210 is also coupled to an audio controller 230. The audio controller is coupled to a microphone 232 as well as a speaker 234.

The processor 210 is also coupled to user interface buttons 240, memory 242, a storage card 244, a universal serial bus connection 246 and a display controller 248. The display controller 246 is in turn coupled to a display 250 such as a liquid crystal display (LCD) type display.

The memory 242 includes both volatile memory such as synchronous dynamic random access memory (SDRAM) and non-volatile memory such as FLASH memory. An annotation module 260 is stored on the memory 242 and executed by the processor 210. The annotation module 260 enables the digital camera 150 to associate annotation information with specific locations within a digital image. The annotation information is encapsulated within an industry standard interactive file format.

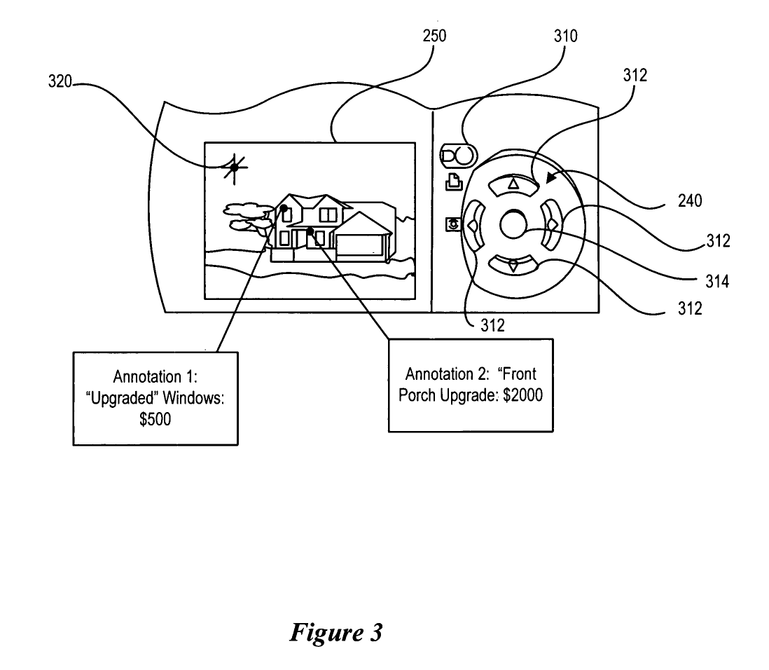

Referring to FIG. 3, an example view a screen and controls of an example digital camera is shown. More specifically, the user interface buttons 240 include an annotation activation button 310 as well as navigation buttons 312 and select button 314.

Upon actuation of the annotation activation button 310, a cursor 320 is displayed on the display 250. The cursor 320 is easily moved up, down, left and right via respective navigation buttons 312. Thus, the navigation buttons 312 function much like a joystick. When the cursor is moved to a specific location for which an annotation is desired, actuation of the select button 314 enables a user to enter an annotation corresponding to the specific location on an image. By associating an annotation with a user selected position, the digital camera can provide the association without the need for additional resources or post processing.

The annotation may be either an audio annotation which is entered via the microphone 232 or a text annotation which is entered via a text entry method. The select button 314 may include the presentation of a selection of an audio annotation or a text annotation and if a text annotation is selected, a text entry screen presentation is presented to the user via the display 250.

Additionally, because the annotations are location specific, multiple annotations may be associated with a single image. For example, if the image were of a house that was for sale, a first annotation might indicate that the house includes upgraded windows at a cost of $500.00 while a second annotation might indicate that the house includes a front porch upgrade at a cost of $2000.00. Each of the annotations would be associated with an appropriate location on the digital image. Thus, the window annotation could be associated with a location on the image corresponding to a window while the porch annotation would be associated with a location on the image corresponding to the porch.

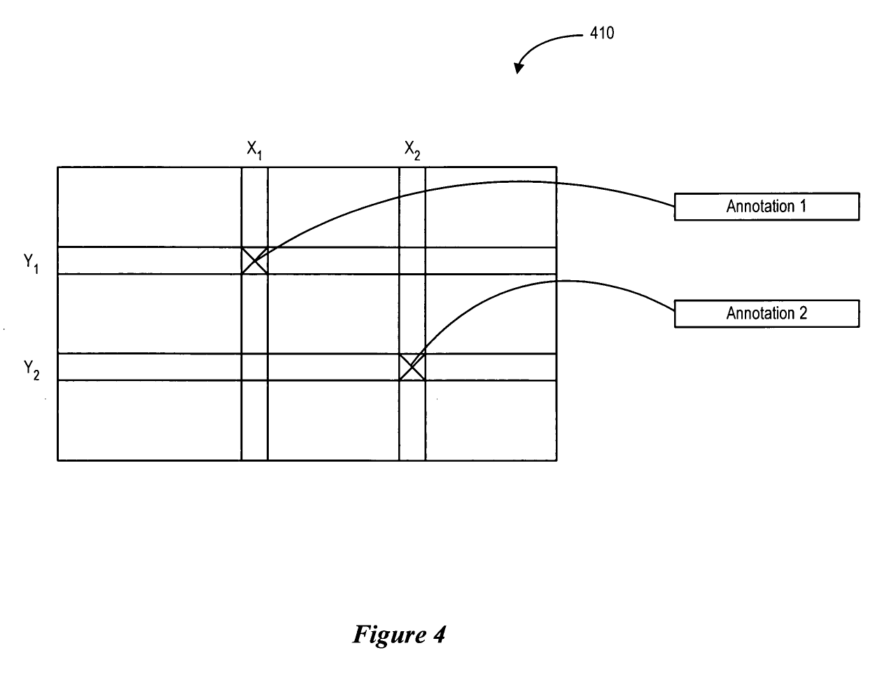

Referring to FIG. 4, a block diagram of an interactive file format for storing position specific annotation information is shown. More specifically, a digital image 410 is divided into a plurality of positions. For example, each position might correspond to a pixel within the digital image. Alternately, each position might have some larger degree of granularity while still enabling position specific annotations.

The position specific annotation information might be stored in an industry standard interactive file format such as the exchangeable image format (EXIF). In this format each annotation would be stored within file headers that are associated with the image. Thus, the file header might include within the file header an entry setting forth a position (e.g., X1, Y1) and the annotation information (e.g., annotation 1) corresponding to that entry and an entry setting forth another position (e.g., X2, Y2) and the annotation information (e.g., annotation 2) corresponding to that entry. The annotation information might be a text file or a digital audio file containing an audio annotation.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, other types of peripherals which can generate digital images (e.g., personal digital assistants (PDAs), video cameras, telephones, etc.) are contemplated.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. An apparatus for generating a digital image comprising:
a processor;
a light sensor coupled to the processor, the light sensor sensing light and generating a digital image corresponding to the light;
a memory coupled to the processor;
an annotation module stored on the memory, the annotation module enabling annotation information to be associated with a specific position within the digital image.

2. The apparatus of claim 1 wherein:
the annotation information is stored in an interactive file format.

3. The apparatus of claim 2 wherein:
the interactive file format conforms to an exchangeable image format type file.

4. The apparatus of claim 1 further comprising:
a microphone coupled to the processor, the microphone receiving audio signals and converting the audio signal to an audio file; and,
wherein,
annotation information includes the audio file; and
the annotation module associates the audio file with a specific position within the digital image.

5. The apparatus of claim 1 wherein:
the specific position corresponds to a pixel of the digital image.

6. The apparatus of claim 1 wherein:
the annotation module associates multiple annotation information with multiple specific positions within the digital image.

7. The apparatus of claim 1 further comprising:
user interface buttons coupled to the processor, the user interface buttons interacting with the annotation module to move a cursor to correspond to the specific position and to control the annotation module to associate the annotation information with the specific position.

8. An information handling system comprising:
a processor;
a light sensor coupled to the processor, the light sensor sensing light and generating a digital image corresponding to the light;
a memory coupled to the processor;
means for enabling annotation information to be associated with a specific position within the digital image.

9. The information handling system of claim 8 wherein:
the annotation information is stored in an interactive file format.

10. The information handling system of claim 9 wherein:
the interactive file format conforms to an exchangeable image format type file.

11. The information handling system of claim 8 further comprising:
a microphone coupled to the processor, the microphone receiving audio signals and converting the audio signal to an audio file; and,
wherein,
annotation information includes the audio file; and
the means for enabling annotation associates the audio file with a specific position within the digital image.

12. The information handling system of claim 8 wherein:
the specific position corresponds to a pixel of the digital image.

13. The information handling system of claim 8 wherein:
the means for enabling associates multiple annotation information with multiple specific positions within the digital image.

14. The information handling system of claim 8 further comprising:
user interface buttons coupled to the processor, the user interface buttons interacting with the annotation module to move a cursor to correspond to the specific position and to control the annotation module to associate the annotation information with the specific position.

15. A method for generating a digital image comprising:
sensing light;
generating a digital image corresponding to the light;
associating annotation information with a specific position within the digital image.

16. The method of claim 15 wherein:
the annotation information is stored in an interactive file format.

17. The method of claim 16 wherein:
the interactive file format conforms to an exchangeable image format type file.

18. The method of claim 15 further comprising:
receiving audio signals;
converting the audio signal to an audio file, the annotation information including the audio file; and,
associating the audio file with a specific position within the digital image.

19. The method of claim 15 wherein:
the specific position corresponds to a pixel of the digital image.

20. The method of claim 15 further comprising:
associating multiple annotation information with multiple specific positions within the digital image.

21. The method of claim 15 further comprising:
providing user interface buttons, the user interface buttons enabling moving of a cursor to correspond to the specific position and controlling the associating to associate the annotation information with the specific position.
